(19) United States
(12) Patent Application Publication
(10) Pub. No.: US 2026/0149879 A1
(43) Pub. Date: May 28, 2026

(54) ELECTRONIC APPARATUS AND CONTROLLING METHOD THEREOF

(71) Applicant: Samsung Electronics Co., Ltd., Suwon-si (KR)

(72) Inventors: Joonyoung HEO, Suwon-si (KR); Hojun BAEK, Suwon-si (KR)

(21) Appl. No.: 19/413,428

(22) Filed: Dec. 9, 2025

Related U.S. Application Data
(63) Continuation of application No. PCT/KR2025/019383, filed on Nov. 20, 2025.

(30) Foreign Application Priority Data
Nov. 20, 2024 (KR) 10-2024-0166552

(51) Int. Cl. H04N 23/667; H04N 23/61; H04N 23/74

(52) U.S. Cl. CPC H04N 23/667; H04N 23/61; H04N 23/74

(57) ABSTRACT

An electronic apparatus is provided. The apparatus includes a first camera sensor, memory including one or more storage media, storing instructions, at least one processor communicatively coupled to the first camera sensor and the memory, wherein the instructions that, when executed by the at least one processor individually or collectively, cause the electronic apparatus to control the first camera sensor to acquire at least one frame based on at least one first frame rate corresponding to a first operation mode while the electronic apparatus travels in a traveling space in the first operation mode, switch from the first operation mode to a second operation mode based on context information related to the traveling space, and control the first camera sensor to acquire at least one frame based on at least one second frame rate corresponding to the second operation mode while the electronic apparatus travels in the traveling space in the switched second operation mode, and wherein the at least one second frame rate comprises a frame rate which is different from the at least one first frame rate.

### CROSS-REFERENCE TO RELATED APPLICATION(S

This application is a continuation application, claiming priority under 35 U.S.C. § 365(c), of an International application No. PCT/KR2025/019383, filed on Nov. 20, 2025, which is based on and claims the benefit of a Korean patent application number 10-2024-0166552, filed on Nov. 20, 2024, in the Korean Intellectual Property Office, the disclosure of which is incorporated by reference herein in its entirety.

### BACKGROUND

### 1. Field

The disclosure relates to an electronic apparatus and a controlling method thereof. More particularly, the disclosure relates to an electronic apparatus for acquiring a plurality of types of frames by considering an operation mode of the electronic apparatus, and a controlling method thereof.

### 2. Description of Related Art

As electronic technology advances, various types of electronic devices have been developed and distributed, and recently, technology development for a robot that provides a service to a user has become active. A robot that travels in a specific space to provide the service to the user may travel by considering context of a traveling path (for example, an object type or a floor type).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus for acquiring a plurality of types of frames by considering an operation mode of the electronic apparatus, and a controlling method thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a first camera sensor, memory including one or more storage media, storing instructions, at least one processor communicatively coupled to the first camera sensor and the memory, wherein the instructions that, when executed by the at least one processor individually or collectively, cause the electronic apparatus to control the first camera sensor to acquire at least one frame based on at least one first frame rate corresponding to a first operation mode while the electronic apparatus travels in a traveling space in the first operation mode, switch from the first operation mode to a second operation mode based on context information related to the traveling space, control the first camera sensor to acquire at least one frame based on at least one second frame rate corresponding to the second operation mode while the electronic apparatus travels in the traveling space in the switched second operation mode, and wherein the at least one second frame rate comprises a frame rate which is different from the at least one first frame rate.

In accordance with another aspect of the disclosure, a method for operating an electronic apparatus is provided. The method includes controlling a first camera sensor to acquire at least one frame based on at least one first frame rate corresponding to a first operation mode while the electronic apparatus travels in a traveling space in the first operation mode, switching from the first operation mode to a second operation mode based on context information related to the traveling space, and controlling the first camera sensor to acquire at least one frame based on at least one second frame rate corresponding to the second operation mode while the electronic apparatus travels in the traveling space in the switched second operation mode, wherein the at least one second frame rate comprises a frame rate which is different from the at least one first frame rate.

In accordance with another aspect of the disclosure, one or more non-transitory computer-readable storage media storing one or more computer programs including computer-executable instructions that, when executed by at least one processor of an electronic apparatus individually or collectively, cause the electronic apparatus to perform operations are provided. The operations include controlling the first camera sensor to acquire at least one frame based on at least one first frame rate corresponding to a first operation mode while the electronic apparatus travels in a traveling space in the first operation mode, switching from the first operation mode to a second operation mode based on context information related to the traveling space. controlling the first camera sensor to acquire at least one frame based on at least one second frame rate corresponding to the second operation mode while the electronic apparatus travels in the traveling space in the switched second operation mode, wherein the at least one second frame rate comprises a frame rate which is different from the at least one first frame rate.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a schematic diagram illustrating an electronic apparatus according to an embodiment of the disclosure;

FIG. 2A is a block diagram illustrating a configuration of an electronic apparatus according to an embodiment of the disclosure;

FIG. 2B is a diagram illustrating a method for operating an electronic apparatus according to an embodiment of the disclosure;

FIG. 2C is a diagram illustrating a method for operating an electronic apparatus according to an embodiment of the disclosure;

FIG. 2D is a diagram illustrating a method for operating an electronic apparatus according to an embodiment of the disclosure;

FIG. 3 is a flowchart illustrating a method for operating an electronic apparatus according to an embodiment of the disclosure;

FIG. 4 is a flowchart illustrating a method for identifying a second frame rate according to an embodiment of the disclosure;

FIG. 5A is a flowchart illustrating a method for operating an electronic apparatus that corresponds to an entry event into a dead-end space according to an embodiment of the disclosure;

FIG. 5B is a diagram illustrating a method for operating an electronic apparatus that corresponds to an entry event into a dead-end space according to an embodiment of the disclosure;

FIG. 5C is a diagram illustrating a method for operating an electronic apparatus that corresponds to an entry event into a dead-end space according to an embodiment of the disclosure;

FIG. 6 is a flowchart illustrating a method for operating an electronic apparatus that corresponds to an entry event into a dead-end space according to an embodiment of the disclosure;

FIG. 7A is a flowchart illustrating a method for operating an electronic apparatus that corresponds to a carpet detection event according to an embodiment of the disclosure;

FIG. 7B is a diagram illustrating a method for operating an electronic apparatus that corresponds to a carpet detection event according to an embodiment of the disclosure;

FIG. 7C is a diagram illustrating a method for operating an electronic apparatus that corresponds to a carpet detection event according to an embodiment of the disclosure;

FIG. 8A is a flowchart illustrating a method for operating an electronic apparatus that corresponds to a first region entry event according to an embodiment of the disclosure;

FIG. 8B is a diagram illustrating a method for operating an electronic apparatus that corresponds to a first region entry event according to an embodiment of the disclosure;

FIG. 8C is a diagram illustrating a method for operating an electronic apparatus that corresponds to a first region entry event according to an embodiment of the disclosure;

FIG. 9A is a flowchart illustrating a method for operating an electronic apparatus that corresponds to a second region entry event according to an embodiment of the disclosure;

FIG. 9B is a diagram illustrating a method for operating an electronic apparatus that corresponds to a second region entry event according to an embodiment of the disclosure;

FIG. 10A is a flowchart illustrating a method for controlling a second camera sensor according to an embodiment of the disclosure;

FIG. 10B is a diagram illustrating a method for controlling a second camera sensor according to an embodiment of the disclosure; and

FIG. 11 is a block diagram illustrating a specific configuration of an electronic apparatus according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

General terms that are currently widely used are selected as terms used in embodiments of the disclosure based on their functions in the disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in corresponding descriptions of the disclosure. Therefore, the terms used in the disclosure need to be defined based on the meanings of the terms and the contents throughout the disclosure rather than simple names of the terms.

In the disclosure, the expression, such as "have", "may have", "include", or "may include", indicates the presence of a corresponding feature (for example, a numerical value, a function, an operation, or a component, such as a part), and does not exclude the presence of an additional feature.

An expression, such as "at least one of A or/and B" may indicate either "A or B", or "both of A and B."

Expressions, such as "first" and "second," used in the disclosure may indicate various components regardless of the sequence or importance of the components. The expression is used only to distinguish one component from another component, and does not limit the corresponding component.

If any component (for example, a first component) is mentioned to be "(operatively or communicatively) coupled with/to" or "connected to" another component (for example, a second component), it should be understood that the any component is directly coupled to another component or may be coupled to another component through yet another component (for example, a third component).

It should be understood that a term "include" or "have" used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the disclosure, a "module" or a "~er/~or" may perform at least one function or operation, and be implemented by hardware, software, or a combination of hardware and software. In addition, a plurality of "modules" or a plurality of "~ers/~ors" may be integrated in at least one module and be implemented by the processor (not shown) except for a "module" or a "~er/or" that needs to be implemented by a specific hardware.

In addition, in this specification, a term, such as "signal" may include not only an electrical signal but also a signal in the form of a sound wave, and the electrical signal may be an analog signal as well a digital signal. For example, an expression, such as "audio signal (or noise signal)" indicates a sound wave (or radio wave) signal if the signal is outside the electronic apparatus, and indicates the electrical signal if the signal is inside the electronic apparatus, depending on its position. In addition, signal processing or the like inside the electronic apparatus described below may be not only digital signal processing but also analog signal processing, or a signal processing method that uses a mixture of analog and digital methods.

In addition, in this specification, a term, such as "filter" indicates a device for removing a specific component (e.g., a specific frequency region or a specific pattern), and the filter may be a digital filter or an analog filter.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

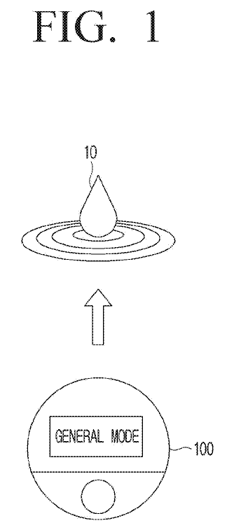

FIG. 1 is a schematic diagram illustrating an electronic apparatus according to an embodiment of the disclosure.

Referring to FIG. 1, according to an embodiment of the disclosure, an electronic apparatus 100 may travel in a traveling space in a first operation mode. For example, the first operation mode may refer to a default operation mode. For example, the electronic apparatus 100 may switch its operation mode based on at least one type of frame acquired using at least one sensor while the electronic apparatus 100 travels in the traveling space in the first operation mode.

For example, the electronic apparatus 100 may acquire at least one type of frame at a predetermined rate. For example, at least one type of frame may include a different type of frame, including a frame used for near-field object recognition (or, detection), a frame used for far-field object recognition, or a frame used for liquid detection.

For example, the electronic apparatus 100 may switch from the first operation mode to a second operation mode based on context information related to the traveling space while the electronic apparatus 100 travels in the traveling space. For example, the electronic apparatus 100 may switch to the second operation mode if its distance to an object 10 is identified as being less than the predetermined distance. For example, the second operation mode may be a mode specialized for liquid detection. For example, if operated in the second operation mode, the electronic apparatus 100 may have a higher acquisition rate of frames used for liquid detection among at least one type of frame compared to the first operation mode.

For example, the electronic apparatus 100 may travel in the traveling space in the second operation mode. In case of traveling in the traveling space in the second operation mode, the electronic apparatus 100 may have the higher acquisition rate of frames used for liquid detection compared to a case of traveling in the traveling space in the first operation mode, and the electronic apparatus 100 may perform a liquid detection operation more accurately.

The following description describes various embodiments of adjusting an acquisition rate of at least one type of frame by considering context related to the traveling space and providing a service to a user based on a frame acquired at the adjusted rate.

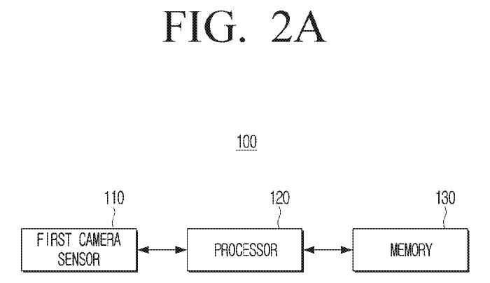

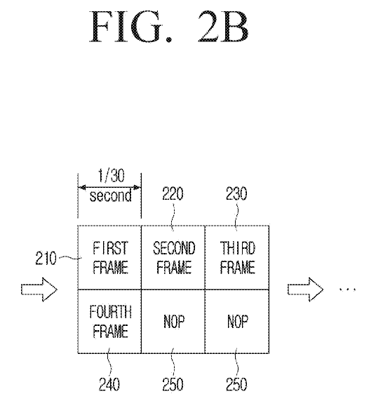

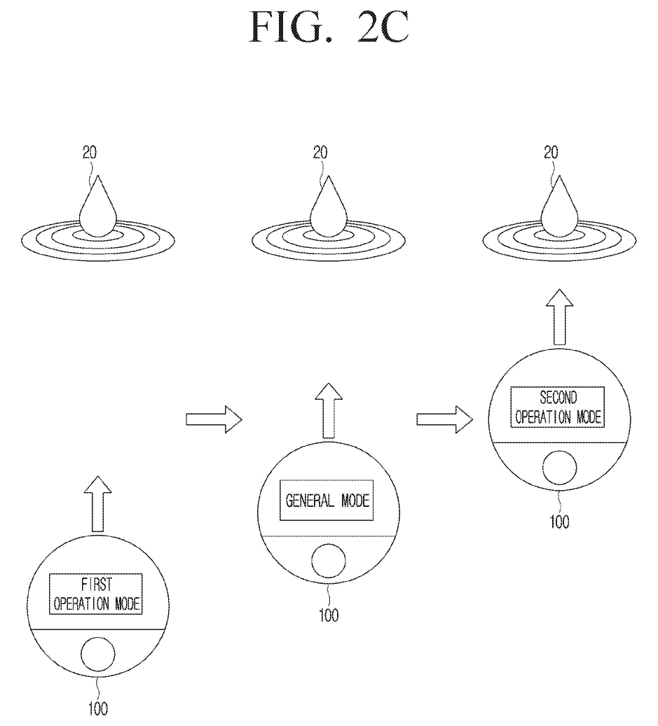

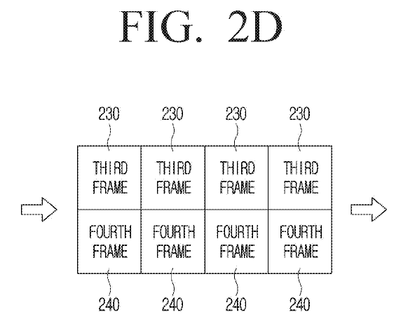

FIG. 2A is a block diagram illustrating a configuration of an electronic apparatus according to an embodiment of the disclosure. FIGS. 2B, 2C, and 2D is a diagram illustrating a method for operating an electronic apparatus according to various embodiments of the disclosure.

Referring to FIG. 2A, the electronic apparatus 100 may include a first camera sensor 110, a processor 120, and memory 130.

The electronic apparatus 100 may be implemented as a different type of device that travels in the traveling space. For example, the electronic apparatus 100 may be a robot that moves to a specific position and provides a service to the user. For example, the electronic apparatus 100 may be implemented as a robot vacuum cleaner that travels in the traveling space and performs a cleaning operation. For example, the electronic apparatus 100 may be a different type of travel robot including a wheel robot, and is not limited thereto.

According to an embodiment of the disclosure, the first camera sensor 110 may include a lens for focusing a visible light or another optical signal reflected from the object and received onto an image sensor, and the image sensor capable of detecting visible light or another optical signal. Here, the image sensor may include a two-dimensional (2D) pixel array divided into a plurality of pixels.

According to an embodiment of the disclosure, the first camera sensor 110 may be a stereo camera implemented as an infrared (IR) camera, is not limited thereto, and may be implemented as a different type of camera.

According to an embodiment of the disclosure, the first camera sensor 110 may acquire a frame. For example, the frame may include an image corresponding to the traveling space. For example, the first camera sensor 110 may acquire the frame at a predetermined frame per second (FPS).

For example, the first camera sensor 110 may acquire a different type of frame. For example, the first camera sensor 110 may acquire at least one of a first frame, a second frame, or a third frame. For example, the first camera sensor 110 may include at least one light-emitting element (e.g., an infrared light-emitting diode (IR LED)) that emits light. For example, the first frame may be an image acquired at a first illuminance as light is emitted from the light-emitting element. For example, the second frame may be an image acquired at a second illuminance greater than or equal to the first illuminance as light is emitted from the light-emitting element. For example, the third frame may be an image acquired from light emitted at a first angle from the light-emitting element.

For example, the first frame may include an image for identifying an object that is positioned at a relatively close position from the electronic apparatus 100, compared to the second frame. For example, the first frame may be an image acquired by receiving reflected light onto the first camera sensor 110 after light having a dot pattern that is emitted while having an intensity less than a predetermined value is emitted to the traveling space by using the IR LED included in the first camera sensor 110. If light is emitted while having the intensity less than the predetermined value, the electronic apparatus 100 may have difficulty in recognizing the dot pattern corresponding to an object positioned at a relatively long distance from the first camera sensor 110. Accordingly, the electronic apparatus 100 may have a better recognition rate of the object that is positioned at a relatively close position.

For example, the second frame may include an image for identifying the object that is positioned at a relatively long distance from the electronic apparatus 100 compared to the first frame. For example, the second frame may be an image acquired by receiving reflected light onto the first camera sensor 110 after light having the dot pattern that is emitted while having an intensity greater than the predetermined value is emitted to the traveling space by using the IR LED included in the first camera sensor 110. If light is emitted while having the intensity greater than the predetermined value, the electronic apparatus 100 may have difficulty in recognizing the dot pattern corresponding to the object positioned at a relatively close distance from the first camera sensor 110. Accordingly, the electronic apparatus 100 may have a better recognition rate of the object that is positioned at a relatively long distance.

For example, the third frame may be acquired from light emitted from the light-emitting element at the first angle. For example, the third frame may be an image acquired by receiving reflected light onto the first camera sensor 110 light emitted at the first angle from the light-emitting element (e.g., the IR LED) included in the first camera sensor 110 is emitted into the traveling space.

For example, the first angle may be an arrangement angle of the light-emitting element inside the electronic apparatus 100. For example, the first angle may be an arrangement angle at which light emitted from the light-emitting element is concentrated onto a specific region inside the traveling space. Alternatively, for example, the first angle may be an arrangement angle at which light emitted from the light-emitting element is radiated.

For example, the first camera sensor may include the plurality of light-emitting elements. For example, a light-emitting element (or a second light-emitting element) used for acquiring the third frame may be different from a light-emitting element (or a first light-emitting element) used for acquiring the first frame or the second frame. For example, the second light-emitting element may be disposed at a relatively lower position than the first light-emitting element inside the electronic apparatus 100. However, the disclosure is not limited thereto, and the first frame, the second frame, and the third frame may be acquired from the same light-emitting element.

For example, the first frame and the second frame may be images used for acquiring depth information of the traveling space. For example, the third frame may be an image (e.g., an IR torch image) used for detecting liquid present inside the traveling space.

The processor 120 (hereinafter, the processor) may be electrically connected to the first camera sensor 110 and the memory 130 and control overall operations of the electronic apparatus 100. The processor 120 may include one or more processors. More particularly, the processor 120 may perform the operation of the electronic apparatus 100 according to the various embodiments of the disclosure by executing at least one instruction stored in the memory 130.

According to an embodiment of the disclosure, the processor 120 may be implemented as a digital signal processor (DSP), a microprocessor, a graphics-processing unit (GPU), an artificial intelligence (AI) processor, a neural processing unit (NPU), or a timing controller (TCON) for processing a digital signal. However, the processor 120 is not limited thereto, and may include at least one of a central processing unit (CPU), a micro controller unit (MCU), a micro processing unit (MPU), a controller, an application processor (AP), or a communication processor (CP), an advanced RISC machine (ARM) processor, or may be defined by a relevant term. In addition, the processor 120 may be implemented as a system-on-chip (SoC), a large scale integration (LSI) that has a processing algorithm embedded therein, or may be implemented in the form of an application specific integrated circuit (ASIC) or a field programmable gate array (FPGA).

The memory 130 may store data required for various embodiments of the disclosure. The memory 130 may be implemented as memory embedded in the electronic apparatus 100 or as memory detachably attached to the electronic apparatus 100, based on a data storage purpose. For example, data for operating the electronic apparatus 100 may be stored in the memory embedded in the electronic apparatus 100, and data for expanded functions of the electronic apparatus 100 may be stored in the memory detachably attached to the electronic apparatus 100.

Meanwhile, the memory embedded in the electronic apparatus 100 may be implemented as at least one of volatile memory (e.g., dynamic random access memory (DRAM), static RAM (SRAM), or synchronous dynamic RAM (SDRAM)) or non-volatile memory (e.g., one time programmable read only memory (OTPROM), programmable ROM (PROM), erasable and programmable ROM (EPROM), electrically erasable and programmable ROM (EEPROM), mask ROM, or flash ROM), flash memory (e.g., NAND flash or NOR flash), hard drive, or solid state drive (SSD)). In addition, the memory detachably attached to the electronic apparatus 100 may be implemented as memory card (e.g., a compact flash (CF), a secure digital (SD), a micro secure digital (Micro-SD), a mini secure digital (Mini-SD), an extreme digital (xD), or a multi-media card (MMC)), or external memory which may be connected to a universal serial bus (USB) port (e.g., USB memory).

According to an embodiment of the disclosure, the processor 120 may travel in the traveling space in the first operation mode. For example, the first operation mode may be the default operation mode in which the electronic apparatus 100 performs the cleaning operation while the electronic apparatus 100 travels in the traveling space. For example, the processor 120 may control the first camera sensor 110 to acquire the first frame, the second frame, and the third frame based on a first frame rate corresponding to the first operation mode while the electronic apparatus 100 travels in the traveling space in the first operation mode.

For example, the frame rate may be a ratio of the first frame, the second frame, and the third frame acquired using the first camera sensor 110 during a predetermined period. For example, the predetermined period may be one second, and may be a different time. For example, the frame rate may be a ratio of the FPS corresponding to each type of frame. For example, the frame rate may be a rate of the FPS corresponding to the first frame, FPS corresponding to the second frame, and the FPS corresponding to the third frame.

For example, the processor 120 may acquire at least one of the first frame, the second frame, or the third frame at different frame rates based on the operation mode. For example, the processor 120 may travel in the traveling space in at least one operation mode including the first operation mode, and a frame rate corresponding to each of at least one operation mode may be stored in the memory 130. For example, the processor 120 may identify the first frame rate corresponding to the first operation mode (e.g., the first frame: the second frame: the third frame = 1:1:1) based on information stored in the memory 130. The processor 120 may control the first camera sensor 110 to acquire the first frame, the second frame, and the third frame at the identified first frame rate.

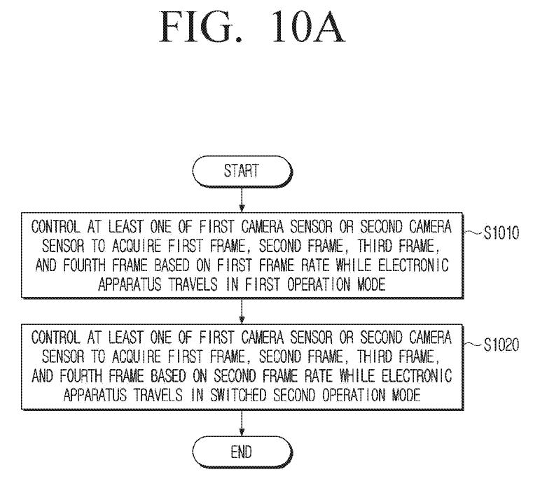

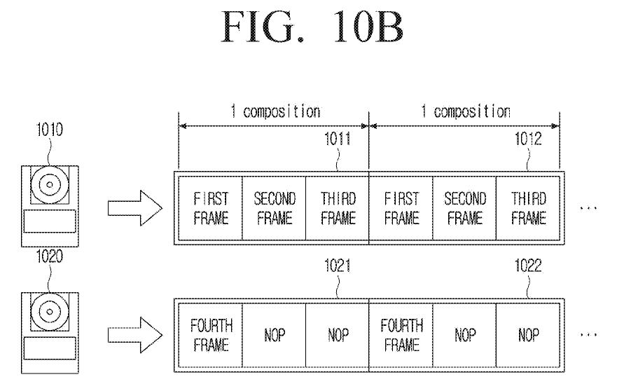

Referring to FIG. 2B, the processor 120 may acquire a first frame 210, a second frame 220, and a third frame 230 in a predetermined order. For example, the processor may sequentially acquire the first frame 210, the second frame 220, and the third frame 230, and acquire the first frame 210 again after the third frame 230 is acquired. However, the disclosure is not limited thereto, and an acquisition order of frames may be randomly changed while maintaining the frame rate corresponding to the operation mode. Meanwhile, for example, the processor 120 may acquire a fourth frame 240, which is different from the first frame 210, the second frame 220, or the third frame 230, at the predetermined rate by using the second camera sensor that is different from the first camera sensor 110. Meanwhile, NOP 250 indicates no operation (or no work), and the second camera sensor is described with reference to FIGS. 10A and 10B.

Referring back to FIG. 2A, according to an embodiment of the disclosure, the processor 120 may switch from the first operation mode to the second operation mode. For example, the second operation mode may be a liquid detection mode, which is a different operation mode than the first operation mode. For example, the processor 120 may switch from the first operation mode to the second operation mode based on the context information related to the traveling space.

For example, the context information related to the traveling space may include at least one of information about the presence and position of an object (e.g., dust or liquid) in a traveling path of the electronic apparatus 100, information about a width of a passage included in the traveling space, or information about a type of floor surface of the traveling path (e.g., carpet or marble). For example, the processor 120 may acquire the context information related to the traveling space based on the sensing data acquired using a different type of sensor including the first camera sensor 110 (e.g., a light detection and ranging (LiDAR) sensor, an ultrasonic sensor, an acceleration sensor, an angular velocity sensor, a gyro sensor, or a motor).

For example, the processor 120 may identify an event related to at least one operation mode of the electronic apparatus 100 based on the context information related to the traveling space. For example, the event related to at least one operation mode may be a trigger event for switching the operation mode.

Referring to FIG. 2C, the processor 120 may identify a liquid detection event as an event related to the second operation mode from at least one operation mode of the electronic apparatus 100 if liquid is detected within the predetermined distance from the electronic apparatus 100 based on the context information. The processor 120 may identify a probability of liquid presence in the traveling path by inputting the sensing data acquired using the different type of sensor including the first camera sensor 110 into a predetermined liquid detection algorithm (For example, a neural network model trained to output the probability of liquid presence in an image if the image of the traveling space is input thereinto). The processor 120 may identify that a liquid detection event occurs if the probability of the presence of the liquid is identified as greater than a first threshold value (e.g., 50%) as a distance between the liquid and the electronic apparatus gets smaller. The processor 120 may switch to the second operation mode if the liquid detection event occurs. This configuration is described below.

Referring back to FIG. 2A, for example, the processor 120 may identify a second frame rate, which is different from the first frame rate, as a frame rate corresponding to the second operation mode if the event related to the second operation mode is identified. For example, the processor 120 may identify the second frame rate corresponding to the second operation mode (e.g., the first frame: the second frame: the third frame = 0:0:1) based on the information stored in the memory 130. However, the disclosure is not limited thereto, and for example, the second frame rate may be a rate at which the third frame has a relatively high rate compared to the first frame or the second frame (e.g., the first frame: the second frame: the third frame = 1:1:10).

For example, the processor 120 may switch the operation mode of the electronic apparatus 100 from the first operation mode to the second operation mode. For example, the processor 120 may change a setting value of the first camera sensor 110 to acquire the first frame, the second frame, and the third frame at the second frame rate corresponding to the second operation mode if the event related to the second operation mode is identified.

According to an embodiment of the disclosure, the processor 120 may control the first camera sensor 110 to acquire the first frame, the second frame, and the third frame based on the second frame rate. For example, the processor 120 may control the first camera sensor 110 to acquire the first frame, the second frame, and the third frame based on the second frame rate corresponding to the second operation mode while the electronic apparatus 100 travels in the traveling space in the switched second operation mode.

Referring to FIG. 2D, the processor 120 may acquire only the third frame 230 by using the first camera sensor while the electronic apparatus 100 travels in the second operation mode without acquiring the first frame 210 or the second frame 220, if the second frame rate is identified as (the first frame 210: the second frame 220: the third frame 230 = 0:0:1). However, the disclosure is not limited, and the second frame rate may be different from what is shown in FIG. 2D. Meanwhile, for example, the processor 120 may acquire the fourth frame 240 by using the second camera sensor at the same rate as the third frame 230, and a method for acquiring the frames by using the second camera sensor is described with reference to FIGS. 10A and 10B.

Referring again to FIG. 2A, according to an embodiment of the disclosure, the processor 120 may terminate the second operation mode and switch to the first operation mode if the event related to the second operation mode is identified as terminated while the electronic apparatus 100 travels in the traveling space in the second operation mode. For example, the processor 120 may identify that the event related to the second operation mode is terminated if liquid is identified as not being detected for a predetermined time or more while the electronic apparatus 100 travels in the traveling space in the second operation mode. For example, the processor 120 may terminate the second operation mode and switch to the first operation mode if the event related to the second operation mode is terminated. For example, the processor 120 may control the first camera sensor 110 to acquire the frame at the first frame rate corresponding to the first operation mode.

In the aforementioned example, the electronic apparatus 100 may adjust the rate of the plurality of types of frames based on the context related to the traveling space. For example, if liquid is suspected to be present on the traveling path, the electronic apparatus 100 may accurately identify liquid present on the traveling path by increasing a third frame rate related to liquid detection. Accordingly, the electronic apparatus 100 may smoothly perform an operation for traveling to avoid liquid or cleaning liquid, thereby improving user satisfaction.

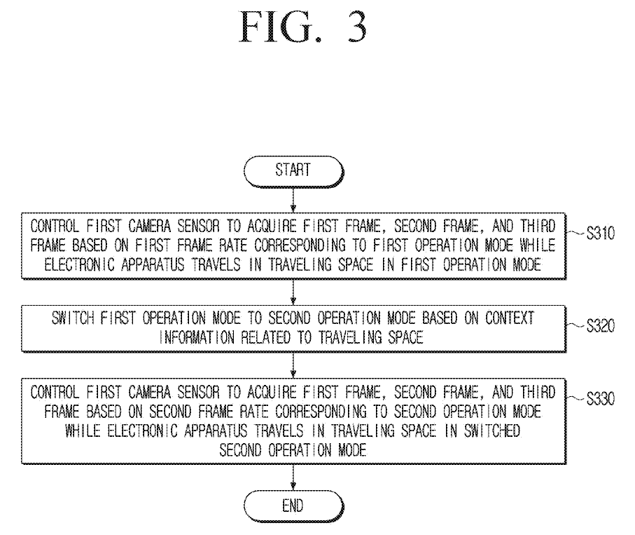

FIG. 3 is a flowchart illustrating a method for operating an electronic apparatus according to an embodiment of the disclosure.

Referring to FIG. 3, according to an embodiment of the disclosure, the operation method may include an operation for controlling the first camera sensor 110 to acquire the first frame, the second frame, and the third frame based on the first frame rate corresponding to the first operation mode while the electronic apparatus 100 travels in the traveling space in the first operation mode at operation S310.

For example, the electronic apparatus 100 may acquire the first frame, the second frame, and the third frame based on the first frame rate corresponding to the first operation mode by using the first camera sensor while the electronic apparatus 100 travels in the traveling space in the first operation mode.

According to an embodiment of the disclosure, the operation method may include an operation for switching the first operation mode to the second operation mode based on the context information related to the traveling space at operation S320.

For example, the electronic apparatus 100 may acquire the context information related to the traveling space by using at least one sensor (e.g., the first camera sensor 110). The electronic apparatus 100 may switch from the first operation mode to the second operation mode if the second operation mode is identified based on the context information related to the traveling space.

According to an embodiment of the disclosure, the operation method may include an operation for controlling the first camera sensor to acquire the first frame, the second frame, and the third frame based on the second frame rate corresponding to the second operation mode while the electronic apparatus 100 travels in the traveling space in the switched second operation mode at operation S330.

For example, the electronic apparatus 100 may acquire the first frame, the second frame, and the third frame by using the first camera sensor 110 based on the second frame rate corresponding to the second operation mode while the electronic apparatus 100 travels in the traveling space in the second operation mode. For example, the second frame rate may be different from the first frame rate.

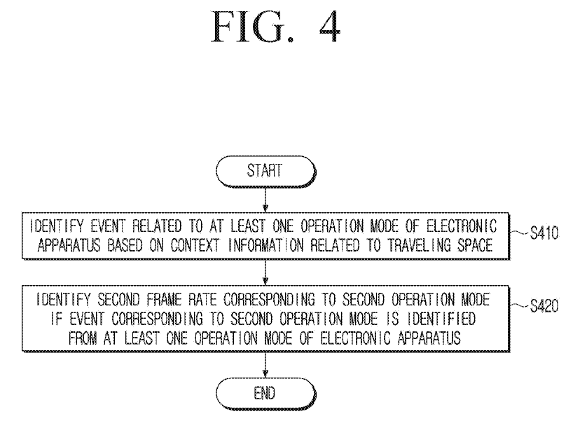

FIG. 4 is a flowchart illustrating a method for identifying the second frame rate according to an embodiment of the disclosure.

Referring to FIG. 4, according to an embodiment of the disclosure, the operation method may include an operation for identifying the event related to at least one operation mode of the electronic apparatus 100 based on the context information related to the traveling space at operation S410.

For example, the context information related to the traveling space may include at least one of the information about the presence and position of the object (e.g., dust or liquid) in the traveling path of the electronic apparatus 100, the information about the width of the passage included in the traveling space, or the information about the type of floor surface of the traveling path (e.g., the carpet or the marble).

For example, the electronic apparatus 100 may identify the context information related to the traveling space based on the sensing data acquired using the different type of sensor including the first camera sensor 110 (e.g., the LiDAR sensor, the second camera sensor, the ultrasonic sensor, the acceleration sensor, the angular velocity sensor, the gyro sensor, or the motor).

For example, the electronic apparatus 100 may identify at least one of the information about the presence or position of the object in the traveling path by inputting the first frame, the second frame, and the third frame acquired using the first camera sensor 110 into a predetermined algorithm (e.g., the trained neural network model). Alternatively, the electronic apparatus 100 may identify the context information including the width of the passage included in the traveling space or the type of floor surface of the traveling path based on the acquired sensing data if sensing data of the traveling space is acquired using the LiDAR sensor or the second camera sensor.

Alternatively, for example, the electronic apparatus 100 may identify the context information based on map information about the traveling space. For example, the map information about the traveling space may include different types of information, including information about a shape of the traveling space or information about a position of the electronic apparatus 100 within the traveling space. For example, the map information about the traveling space may include information about a floor surface type (e.g., carpet or marble) of a predetermined region within the traveling space. Alternatively, the map information about the traveling space may store information about the position of an object (e.g., an appliance or a piece of furniture) present within the traveling space.

For example, the electronic apparatus 100 may acquire the map information about the traveling space based on a user input. For example, if the user input is received to identify that the floor surface type of a first region in the traveling space is the carpet, the electronic apparatus 100 may update the map information to identify the floor surface type of the first region as the carpet based on the user input. However, the disclosure is not limited thereto, and for example, the electronic apparatus 100 may identify the floor surface type of the first region based on the sensing data acquired using the different type of sensor including the first camera sensor 110.

For example, the electronic apparatus 100 may identify at least one event based on the context information related to the traveling space. For example, the electronic apparatus 100 may identify the liquid detection event if a probability that liquid is present on the traveling path is greater than or equal to the first threshold value based on the context information related to the traveling space. Alternatively, for example, the electronic apparatus 100 may identify an entry event into a dead-end space if the width of the passage included in the traveling path is less than the predetermined value. Alternatively, the electronic apparatus 100 may identify a carpet entry event if the floor surface of a region into which the electronic apparatus 100 enters or is to enter is identified as the carpet. A specific method for identifying an event based on the context information is described below.

According to an embodiment of the disclosure, the operation method may include an operation for identifying the second frame rate corresponding to the second operation mode if an event corresponding to the second operation mode is identified from at least one operation mode of the electronic apparatus 100 at operation S420.

For example, the electronic apparatus 100 may identify an operation mode corresponding to the identified event as the second operation mode if at least one event corresponding to the second operation mode is identified based on the context information. For example, the electronic apparatus 100 may identify the second frame rate corresponding to the identified second operation mode. For example, the electronic apparatus 100 may identify the second frame rate based on the information stored in the memory 130.

For example, the second operation mode may be the liquid detection mode, and a third frame rate corresponding to the second operation mode may be greater than or equal to a third frame rate corresponding to the first operation mode. For example, assume that the first frame rate is (the first frame: the second frame: the third frame = 1:1:1), and the third frame rate is (the first frame: the second frame: the third frame = 0:0:1). The third frame rate corresponding to the first operation mode may be 33%, and the third frame rate corresponding to the second operation mode may be 100%. The electronic apparatus 100 may acquire relatively more third frames while switching to the second operation mode, and thus more accurately detect liquid in the traveling space.

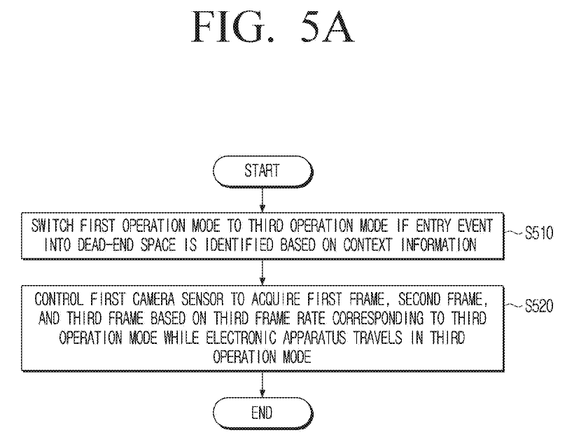

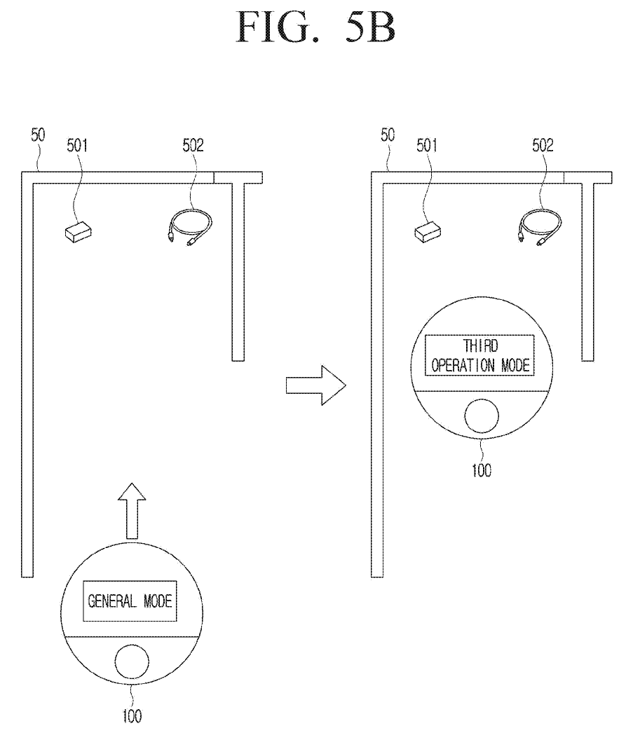

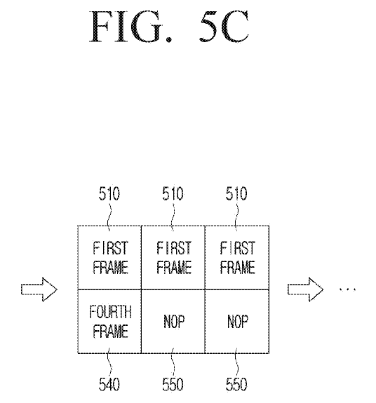

FIGS. 5A, 5B, and 5C is a flowchart or a diagram illustrating a method for operating an electronic apparatus that corresponds to an entry event into a dead-end space according to various embodiments of the disclosure.

Referring to FIG. 5A, according to an embodiment of the disclosure, the operation method may include an operation for switching the first operation mode to a third operation mode if the entry event into the dead-end space is identified based on the context information at operation S510.

For example, the electronic apparatus 100 may identify the entry event into the dead-end space based on the context information. For example, the electronic apparatus 100 may identify whether the dead-end space is present in the traveling path of the electronic apparatus 100 by inputting at least one of the first frame, the second frame, or the third frame acquired using the first camera sensor 110 into the predetermined algorithm. The electronic apparatus 100 may identify that the entry event into the dead-end space occurs if the electronic apparatus 100 is identified as being positioned within the predetermined distance from the identified dead-end space while the electronic apparatus 100 travels. Alternatively, for example, the electronic apparatus 100 may identify whether the electronic apparatus 100 is positioned within the predetermined distance from the dead-end space based on the map information about the traveling space, and identify that the entry event into the dead-end space occurs based thereon.

For example, the electronic apparatus 100 may switch from the first operation mode to the third operation mode if the entry event into the dead-end space is identified. For example, the third operation mode may be a mode that is different from the first operation mode and in which the electronic apparatus 100 may more accurately detect an object present at a close range.

According to an embodiment of the disclosure, the operation method may include an operation for controlling the first camera sensor 110 to acquire the first frame, the second frame, and the third frame based on a third frame rate corresponding to the third operation mode while the electronic apparatus 100 travels in the third operation mode at operation S520.

For example, the electronic apparatus 100 may acquire the first frame, the second frame, and the third frame based on the third frame rate corresponding to the third operation mode while the electronic apparatus 100 travels in the third operation mode. For example, the third frame rate may be a frame rate at which the first frame has a relatively high rate (e.g., the first frame: the second frame: the third frame = 1:0:0), is not limited thereto, and may also be a different frame rate (e.g., the first frame: the second frame: the third frame = 10:1:1).

For example, a first frame rate corresponding to the third operation mode may be greater than or equal to the first frame rate corresponding to the first operation mode. For example, the first frame rate may be 100% if the third frame rate corresponding to the third operation mode is (the first frame: the second frame: the third frame = 1:0:0), and the first frame rate may be 33% if the first frame rate corresponding to the first operation mode is (the first frame: the second frame: the third frame = 1:1:1).

For example, if the entry event into the dead-end space is identified, the electronic apparatus 100 may identify the third operation mode corresponding to the entry event into the dead-end space and identify the third frame rate corresponding to the identified third operation mode. The electronic apparatus 100 may acquire the frame by using the first camera sensor 110 based on the identified third frame rate while the electronic apparatus 100 travels in the third operation mode.

Referring to FIG. 5B, the electronic apparatus 100 may switch from the first operation mode to the third operation mode if the entry event into a dead-end space 50 is identified while the electronic apparatus 100 travels in the first operation mode. For example, the electronic apparatus 100 may identify the entry event into the dead-end space 50 if the electronic apparatus 100 is identified as being positioned within the predetermined distance from the dead-end space 50 based on the context information. The electronic apparatus 100 may terminate the first operation mode and switch to the third operation mode if the entry event into the dead-end space 50 is identified. The electronic apparatus 100 may acquire the frame by using the first camera sensor 110 at the third frame rate corresponding to the third operation mode.

If the electronic apparatus 100 is positioned in the dead-end space 50, the electronic apparatus 100 needs to accurately identify objects 501 and 502 positioned at a relatively close range to smoothly provide a service. The electronic apparatus 100 may more accurately detect the objects 501 and 502 by acquiring the first frame, which is effective to identify the objects 501 and 502 present at a close range, at a relatively high proportion.

Referring to FIG. 5C, the electronic apparatus 100 may acquire a first frame 510 (e.g., the first frame 210 in FIG. 2B), the second frame, and the third frame at the third frame rate while the electronic apparatus 100 travels in the third operation mode. For example, if the third frame rate is (the first frame: the second frame: the third frame = 1:0:0), the electronic apparatus 100 may continuously acquire the first frame 510 as shown in FIG. 5C without acquiring the second frame or the third frame. However, unlike as shown in FIG. 5C, the third frame rate may be different. For example, the third frame rate may be a rate at which the first frame 510 has the relatively highest rate value.

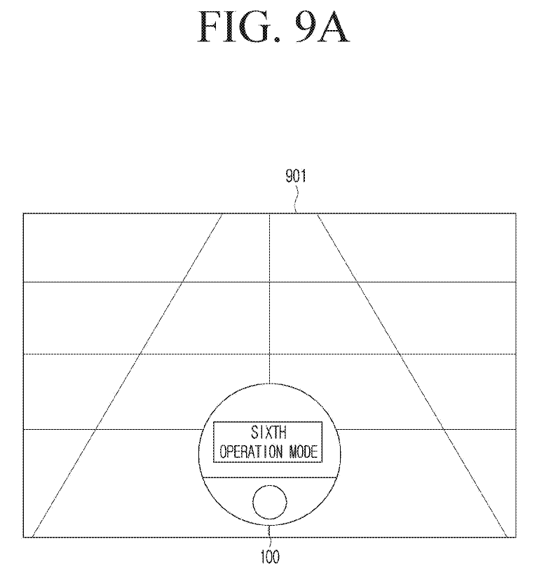

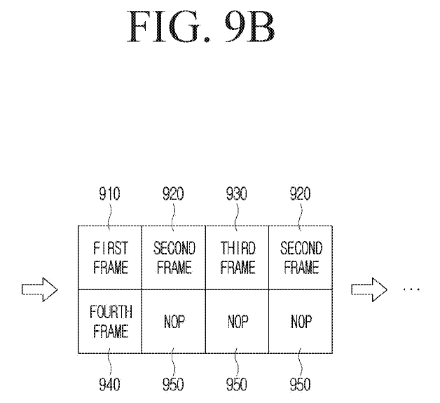

Meanwhile, for example, the electronic apparatus 100 may acquire a fourth frame 540 (e.g., the fourth frame 240 in FIG. 2B or a fourth frame 940 in FIG. 9B), which is different from the first frame, the second frame, and the third frame, at the predetermined rate by using the second camera sensor which is different from the first camera sensor 110. Meanwhile, NOP 550 indicates no operation (or no work), and the method for acquiring the frame by using the second camera sensor is described with reference to FIGS. 10A and 10B.

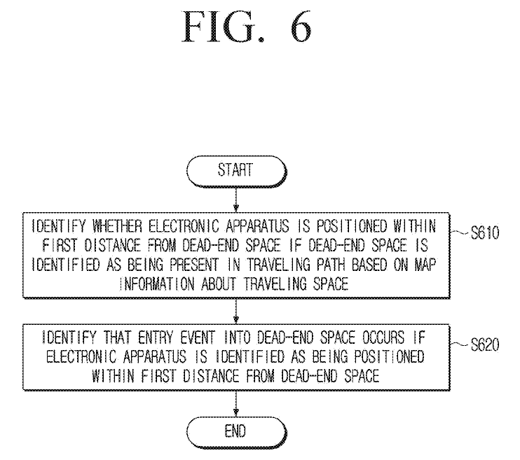

FIG. 6 is a flowchart illustrating a method for operating an electronic apparatus that corresponds to an entry event into a dead-end space according to an embodiment of the disclosure.

Referring to FIG. 6, according to an embodiment of the disclosure, the operation method may include an operation for identifying whether the electronic apparatus 100 is positioned within a first distance from the dead-end space if the dead-end space is identified as being present in the traveling path based on the map information about the traveling space at operation S610.

For example, the electronic apparatus 100 may acquire the map information about the traveling space. For example, the map information about the traveling space may be stored in the memory 130. However, the disclosure is not limited thereto, and for example, the electronic apparatus 100 may acquire the map information about the traveling space from an external device (e.g., a server). For example, the map information about the traveling space may include the different types of information, including the information about the shape of the traveling space, the information about the position of the electronic apparatus 100 within the traveling space.

For example, the electronic apparatus 100 may identify whether the dead-end space is present in the traveling path based on the map information about the traveling space. For example, the electronic apparatus 100 may identify a position of the dead-end space within the traveling space based on the map information about the traveling space. The electronic apparatus 100 may identify whether the dead-end space is present in the traveling path based on the position of the dead-end space.

For example, the electronic apparatus 100 may identify whether the electronic apparatus 100 is positioned within the first distance from the dead-end space if the dead-end space is present in the traveling path. For example, the electronic apparatus 100 may identify a distance between the electronic apparatus 100 and the dead-end space and identify whether the identified distance is within the first distance based on the map information about the traveling space.

According to an embodiment of the disclosure, the operation method may include an operation for identifying that the entry event into the dead-end space occurs if the electronic apparatus 100 is identified as being positioned within the first distance from the dead-end space at operation S620.

For example, the electronic apparatus 100 may identify that the entry event into the dead-end space occurs if the electronic apparatus 100 is identified as being positioned within the first distance from the dead-end space. For example, the electronic apparatus 100 may perform a traveling operation in the third operation mode corresponding to the entry event into the dead-end space. For example, the electronic apparatus 100 may control the first camera sensor 110 to acquire the frame at the third frame rate corresponding to the third operation mode while performing the traveling operation in the third operation mode.

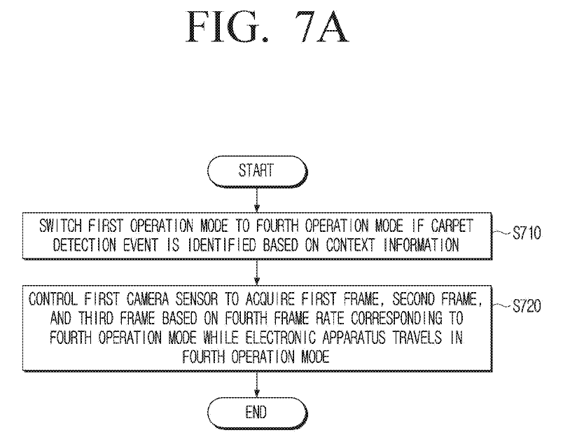

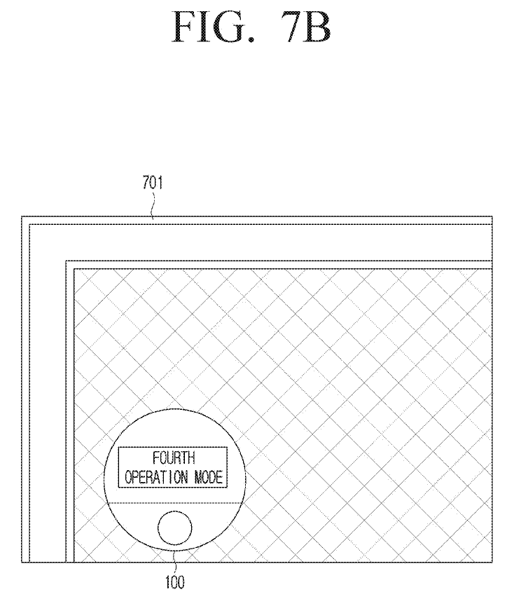

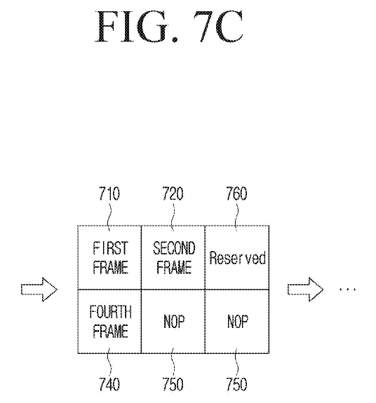

FIGS. 7A, 7B, and 7C is a flowchart or a diagram illustrating a method for operating an electronic apparatus that corresponds to a carpet detection event according to various embodiments of the disclosure.

Referring to FIG. 7A, according to an embodiment of the disclosure, the operation method may include an operation for switching the first operation mode to a fourth operation mode if the carpet detection event is identified based on the context information at operation S710.

For example, the electronic apparatus 100 may identify the carpet detection event based on the context information. For example, the electronic apparatus 100 may identify the floor surface type of the traveling path of the electronic apparatus 100 by inputting at least one of the first frame, the second frame, or the third frame acquired using the first camera sensor 110 into the predetermined algorithm (e.g., an object detection algorithm included in an image). The electronic apparatus 100 may identify whether the electronic apparatus 100 is positioned within the predetermined distance from the identified carpet if the floor surface type of the traveling path is identified while the electronic apparatus 100 travels. The electronic apparatus 100 may identify that the carpet detection event occurs if the electronic apparatus 100 is identified as being positioned within the predetermined distance from the carpet.

Alternatively, for example, the electronic apparatus 100 may identify whether the electronic apparatus 100 is positioned within the predetermined distance from the carpet based on the map information about the traveling space, and identify that the carpet detection event occurs based thereon. For example, the map information about the traveling space may include information about a position of an object present in the traveling space. The electronic apparatus 100 may identify the carpet detection event based on the position of the electronic apparatus 100 and a position of the carpet present in the traveling space.

For example, the electronic apparatus 100 may switch from the first operation mode to the fourth operation mode if the carpet detection event is identified. For example, the fourth operation mode may be a mode that is different from the first operation mode and in which detection of a liquid-type object is disabled.

According to an embodiment of the disclosure, the operation method may include an operation for controlling the first camera sensor 110 to acquire the first frame, the second frame, and the third frame based on a fourth frame rate corresponding to the fourth operation mode while the electronic apparatus 100 travels in the fourth operation mode at operation S720.

For example, the electronic apparatus 100 may acquire the first frame, the second frame, and the third frame based on the fourth frame rate corresponding to the fourth operation mode while the electronic apparatus 100 travels in the fourth operation mode. For example, the fourth frame rate may be a frame rate at which the third frame has a relatively low rate (e.g., the first frame: the second frame: the third frame = 1:1:0), is not limited thereto, and may also be a different frame rate (e.g., the first frame: the second frame: the third frame = 2:1:0).

For example, a third frame rate corresponding to the fourth operation mode may be greater than or equal to the third frame rate corresponding to the first operation mode. For example, the third frame rate may be 0% if the third frame rate corresponding to the third operation mode is (the first frame: the second frame: the third frame = 1:1:0), and the third frame rate may be 33% if the first frame rate corresponding to the first operation mode is (the first frame: the second frame: the third frame = 1:1:1).

For example, if the carpet detection event is identified, the electronic apparatus 100 may identify the fourth operation mode and identify the fourth frame rate corresponding to the identified fourth operation mode. The electronic apparatus 100 may acquire the plurality of types of frames by using the first camera sensor 110 based on the identified fourth frame rate while the electronic apparatus 100 travels in the fourth operation mode.

Referring to FIG. 7B, the electronic apparatus 100 may switch from the first operation mode to the fourth operation mode if a detection event of a carpet 701 is identified while the electronic apparatus 100 travels in the first operation mode. For example, the electronic apparatus 100 may identify the detection event of the carpet 701 if the electronic apparatus 100 is identified as being positioned within the predetermined distance from the carpet 701 based on the context information. The electronic apparatus 100 may terminate the first operation mode and switch to the fourth operation mode if the detection event of the carpet 701 is identified. The electronic apparatus 100 may acquire the frame by using the first camera sensor 110 at the fourth frame rate corresponding to the fourth operation mode.

The carpet 701 may have a property of absorbing liquid, and accordingly, a probability in which the liquid-type object is present on the carpet 701 may relatively be low. The electronic apparatus 100 may perform an efficient operation even while the electronic apparatus 100 travels on the carpet 701 by acquiring the first frame and the second frame, which are effective to detect objects other than the liquid-type object, at a relatively high rate while acquiring the third frame, which is effective to detect liquid, at a relatively low rate.

Referring to FIG. 7C, the electronic apparatus 100 may acquire a first frame 710 (e.g., the first frame 210 in FIG. 2B), a second frame 720 (e.g., the second frame 220 in FIG. 2B) and a third frame at the fourth frame rate while the electronic apparatus 100 travels in the fourth operation mode. For example, if the fourth frame rate is (the first frame: the second frame: the third frame = 1:1:0), the electronic apparatus 100 may acquire the first frame 710 and the second frame 720 as shown in FIG. 7C. For example, a frame 760 corresponding to 'reserved' may be the first frame 710 or the second frame 720.

For example, the electronic apparatus 100 may acquire the frame 760 corresponding to 'reserved' as the first frame 710 or the second frame 720 based on a setting value corresponding to the fourth operation mode. For example, if the fourth frame rate is (the first frame: the second frame: the third frame = 1:1:0), the electronic apparatus 100 may alternately acquire the first frame 710 and the second frame 720 as the frame 760 corresponding to 'reserved'.

Alternatively, for example, if the fourth frame rate is (the first frame: the second frame: the third frame = 2:1:0), the electronic apparatus 100 may acquire the frame 760 corresponding to 'reserved' as the first frame 710. If the first frame 710 is referred to as 'L' and the second frame 720 is referred to as 'H', the first camera sensor 110 may acquire the frames in an acquisition order of (L-H-L-L-H-L). However, the disclosure is not limited thereto, and the first camera sensor 110 may acquire the frames in a different acquisition order under a condition that the fourth frame rate is maintained.

For example, unlike as shown in FIG. 7C, the fourth frame rate may be different, and for example, the fourth frame rate may be a rate at which the third frame has the relatively lowest rate value.

Meanwhile, for example, the electronic apparatus 100 may also acquire a fourth frame 740 (e.g., the fourth frame 240 in FIG. 2B), which is different from the first frame, the second frame, and the third frame, at the predetermined rate by using the second camera sensor which is different from the first camera sensor 110. Meanwhile, NOP 750 indicates no operation (or no work), and the method for acquiring the frame by using the second camera sensor is described with reference to FIGS. 10A and 10B.

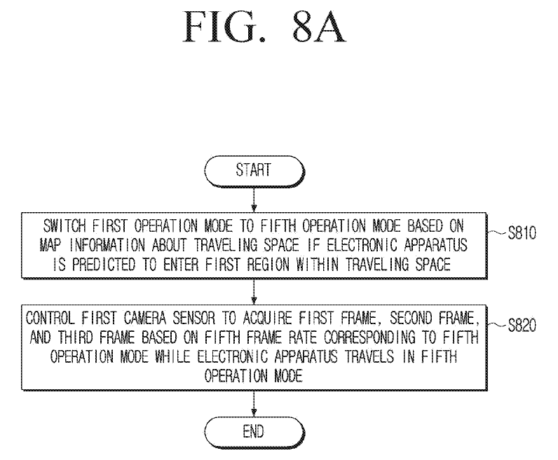

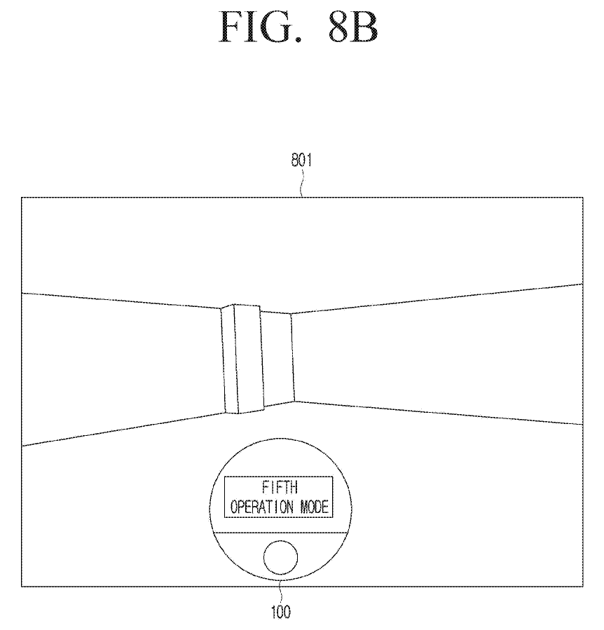

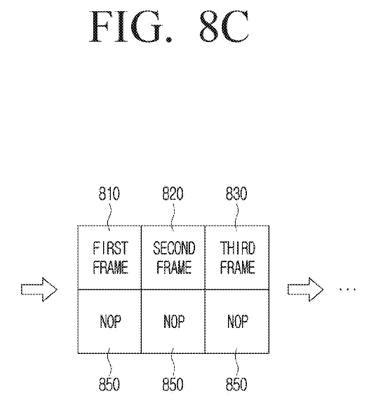

FIGS. 8A, 8B, and 8C is a flowchart or a diagram illustrating a method for operating an electronic apparatus that corresponds to a first region entry event according to various embodiments of the disclosure.

Referring to FIG. 8A, according to an embodiment of the disclosure, the operation method may include an operation for switching the first operation mode to a fifth operation mode based on the map information about the traveling space if the electronic apparatus 100 is predicted to enter the first region within the traveling space at operation S810.

For example, the electronic apparatus 100 may predict whether the electronic apparatus 100 is to enter the first region based on the context information. For example, the first region may be one region within the traveling space where no object is present or a region where the electronic apparatus 100 may easily travel (e.g., a region without the dead-end space), and is not limited to.

For example, the electronic apparatus 100 may identify whether the first region is present within the predetermined distance from the electronic apparatus 100 by inputting at least one of the first frame, the second frame, or the third frame acquired using the first camera sensor 110 into the predetermined algorithm (e.g., the object detection algorithm included in an image). The electronic apparatus 100 may predict that the electronic apparatus 100 is to enter the first region within the traveling space if the electronic apparatus 100 is identified as being present in the first region within the predetermined distance.

Alternatively, for example, the electronic apparatus 100 may identify whether the electronic apparatus 100 is positioned within the predetermined distance from the first region based on the map information about the traveling space, and predict (or estimate) that the electronic apparatus 100 is to enter the first region based thereon. For example, the map information about the traveling space may include information about a type of at least one region present in the traveling space. For example, the type of at least one region may be a type in which the object (e.g., the appliance or the furniture) is not present or a type in which the region includes a large space, and is not limited thereto. The electronic apparatus 100 may predict whether the electronic apparatus 100 is to enter the first region based on a position of the first region and a position of the electronic apparatus 100.

For example, the electronic apparatus 100 may switch from the first operation mode to a fifth operation mode if the electronic apparatus 100 is predicted to enter the first region. For example, the fifth operation mode may be a mode that is different from the first operation mode and in which the fourth frame acquisition using the second camera sensor is disabled.

According to an embodiment of the disclosure, the operation method may include an operation for controlling the first camera sensor 110 to acquire the first frame, the second frame, and the third frame based on a fifth frame rate corresponding to the fifth operation mode while the electronic apparatus 100 travels in the fifth operation mode at operation S820.

For example, the electronic apparatus 100 may acquire the first frame, the second frame, and the third frame based on the fifth frame rate corresponding to the fifth operation mode while the electronic apparatus 100 travels in the fifth operation mode. For example, the fifth frame rate may be a frame rate at which the first frame, the second frame, and the third frame rates are the same.

Meanwhile, for example, if the electronic apparatus 100 includes the second camera sensor, the fifth operation mode may be an operation mode in which the electronic apparatus 100 acquires the fourth frame at the relatively lowest rate, unlike the first operation mode. For example, if the electronic apparatus 100 includes the second camera sensor, the fifth frame rate may be (the first frame: the second frame: the third frame: the fourth frame = 1:1:1:0). However, the disclosure is not limited thereto, and for example, the fifth frame rate may be a rate at which the fourth frame has the relatively lowest rate (for example, the first frame: the second frame: the third frame: the fourth frame = 10:10:10:1).

Referring to FIG. 8B, the electronic apparatus 100 may switch from the first operation mode to the fifth operation mode if the electronic apparatus 100 is predicted to enter the first region while the electronic apparatus 100 travels in the first operation mode. For example, the electronic apparatus 100 may predict that the electronic apparatus 100 is to enter the first region if the electronic apparatus 100 is identified as being positioned within the predetermined distance from the first region based on the context information. The electronic apparatus 100 may terminate the first operation mode and switch to the fifth operation mode if the electronic apparatus 100 is predicted to enter the first region. The electronic apparatus 100 may acquire the frame by using at least one of the first camera sensor 110 and the second camera sensor at the fifth frame rate corresponding to the fifth operation mode.

Referring to FIG. 8C, the electronic apparatus 100 may acquire a first frame 810 (e.g., the first frame 210 in FIG. 2B or a first frame 910 in FIG. 9B), a second frame 820 (e.g., the second frame 220 in FIG. 2B or a second frame 920 in FIG. 9B), and a third frame 830 (e.g., the third frame 230 in FIG. 2B or a third frame 930 in FIG. 9B) at the fifth frame rate while the electronic apparatus 100 travels in the fifth operation mode.

For example, the electronic apparatus 100 may not perform the fourth frame acquisition operation if the fifth frame rate corresponding to the fifth operation mode is identified as (the first frame: the second frame: the third frame: the fourth frame = 1:1:1:0). Accordingly, while the electronic apparatus 100 acquires the frame by using the first camera sensor 110, the second camera sensor may be in a state of NOP 850 or NOP 950 in FIG. 9B. However, for example, unlike as shown in FIG. 8C, if the fifth frame rate is identified as (the first frame: the second frame: the third frame: the fourth frame = 10:10:10:1), the electronic apparatus 100 may acquire the fourth frame based on the fifth frame rate.

FIGS. 9A and 9B is a flowchart or a diagram 901 illustrating a method for operating an electronic apparatus that corresponds to a second region entry event according to various embodiments of the disclosure.

Referring to FIGS. 9A and 9B, according to an embodiment of the disclosure, the electronic apparatus 100 may switch from the first operation mode to a sixth operation mode based on the map information about the traveling space if the electronic apparatus 100 is predicted to enter a second region within the traveling space.

For example, the electronic apparatus 100 may predict whether the electronic apparatus 100 is to enter the second region based on the context information. For example, the second region may be one region of the traveling space whose floor surface is a marble type, and is not limited thereto.

For example, the electronic apparatus 100 may identify whether the second region is present within the predetermined distance from the electronic apparatus 100 by inputting at least one of the first frame, the second frame, or the third frame acquired using the first camera sensor 110 into the predetermined algorithm (e.g., the object detection algorithm included in an image). If the second region is identified as being present within the predetermined distance, the electronic apparatus 100 may predict that the electronic apparatus 100 is to enter the second region within the traveling space.

Alternatively, for example, the electronic apparatus 100 may identify whether the electronic apparatus 100 is positioned within the predetermined distance from the second region based on the map information about the traveling space, and predict (or estimate) that the electronic apparatus 100 is to enter the second region based thereon. For example, the map information about the traveling space may include information about the floor surface type corresponding to at least one region present in the traveling space. The electronic apparatus 100 may predict whether the electronic apparatus 100 is to enter the second region based on a position of the second region and the position of the electronic apparatus 100.

For example, the electronic apparatus 100 may switch from the first operation mode to the sixth operation mode if the electronic apparatus 100 is predicted to enter the second region. For example, the sixth operation mode may be an operation mode that is different from the first operation mode and in which the third frame is acquired at a relatively high rate. If the third frame rate, which is advantageous for liquid detection, is relatively high, the electronic apparatus 100 may accurately detect liquid even in an area where an object is easily reflective, such as the marble.

For example, the electronic apparatus 100 may identify a sixth frame rate corresponding to the sixth operation mode as (the first frame: the second frame: the third frame: the fourth frame = 1:1:2:1) while the electronic apparatus 100 travels in the sixth operation mode. In this case, as shown in FIG. 9B, a second camera sensor 1020 may acquire one fourth frame while a first camera sensor 1010 acquires one first frame, one second frame, and two third frames, respectively. During some time of acquiring the frame by using the first camera sensor 110, the second camera sensor may be in a state of NOP 950.

FIGS. 10A and 10B is a flowchart or a diagram illustrating a method for controlling a second camera sensor according to various embodiments of the disclosure.

Referring to FIGS. 10A and 10B, according to an embodiment of the disclosure, an operation method may include an operation for controlling at least one of the first camera sensor or the second camera sensor to acquire the first frame, the second frame, the third frame, and the fourth frame based on the first frame rate while the electronic apparatus 100 travels in the first operation mode at operation S1010.

For example, the electronic apparatus 100 may include the first camera sensor 1010 (e.g., the first camera sensor 110 in FIG. 2A) and the second camera sensor 1020. For example, the fourth frame may include an image for identifying an object present in the traveling space. For example, the second camera sensor may be implemented as a red-green-blue (RGB) camera, and the fourth frame may be an RGB image.

For example, if the electronic apparatus 100 includes the second camera sensor 1020, the frame rate may be a rate of the first frame, the second frame, and the third frame acquired using the first camera sensor 1010, and the fourth frame acquired using the second camera sensor 1020 during a predetermined period.

For example, the electronic apparatus 100 may identify the first frame rate corresponding to the first operation mode as (the first frame: the second frame: the third frame: the fourth frame = 1:1:1:1). In this case, as shown in FIG. 2B, the second camera sensor 1020 may acquire one fourth frame while the first camera sensor 1010 acquires one first frame, one second frame, and one third frame, respectively. As a result, an FPS corresponding to the second camera sensor 1020 may be less than an FPS corresponding to the first camera sensor 1010.

According to an embodiment of the disclosure, the operation method may include an operation for controlling at least one of the first camera sensor or the second camera sensor to acquire the first frame, the second frame, the third frame, and the fourth frame based on the second frame rate while the electronic apparatus 100 travels in the switched second operation mode at operation S1020.

For example, the electronic apparatus 100 may identify the second frame rate corresponding to the second operation mode as (the first frame: the second frame: the third frame: the fourth frame = 0:0:1:1). In this case, as shown in FIG. 2D, the second camera sensor 1020 may acquire one fourth frame while the first camera sensor 1010 acquires one third frame. However, the disclosure is not limited thereto.

Alternatively, for example, the electronic apparatus 100 may identify the third frame rate corresponding to the third operation mode as (the first frame: the second frame: the third frame: the fourth frame = 3:0:0:1). In this case, as shown in FIG. 5C, the second camera sensor 1020 may acquire one fourth frame while the first camera sensor 1010 acquires three first frames.

Alternatively, for example, the electronic apparatus 100 may identify the fourth frame rate corresponding to the fourth operation mode as (the first frame: the second frame: the third frame: the fourth frame = 1.5:1.5:0:1). In this case, as shown in FIG. 7C, the first camera sensor 1010 may alternately acquire the first frame and the second frame as the frame corresponding to 'reserved'. The second camera sensor 1020 may acquire one fourth frame while the first camera sensor 1010 acquires 1.5 first frames and 1.5 second frames, respectively.

Alternatively, for example, the electronic apparatus 100 may identify the fifth frame rate corresponding to the fifth operation mode as (the first frame: the second frame: the third frame: the fourth frame = 1:1:1:0). In this case, as shown in FIG. 8C, the first camera sensor 1010 may sequentially acquire the first frame, the second frame, and the third frame. The second camera sensor 1020 may not perform the frame acquisition operation.

Alternatively, for example, the electronic apparatus 100 may identify the sixth frame rate corresponding to the sixth operation mode as (the first frame: the second frame: the third frame: the fourth frame = 1:1:2:1). In this case, as shown in FIG. 9B, the second camera sensor 1020 may acquire one fourth frame while the first camera sensor 1010 acquires one first frame, one second frame, and two third frames, respectively.

Meanwhile, according to an embodiment of the disclosure, the first frame, the second frame, the third frame, and the fourth frame may be acquired as a composition. For example, the composition may be a group of frames acquired during the predetermined time. For example, the composition may be a group of frames acquired during 1/10th of a second if it takes 1/30th of a second to acquire a single frame.

For example, in the first operation mode, the electronic apparatus 100 may acquire a composition 1011, 1012, or 1013 including the plurality of frames by using the first camera sensor 1010. For example, the composition 1011, 1012, or 1013 acquired using the first camera sensor 1010 may include one first frame, one second frame, and one third frame, respectively, and is not limited thereto.

Alternatively, for example, in the first operation mode, the electronic apparatus 100 may acquire a composition 1021, 1022, or 1023 including at least one frame by using the second camera sensor 1020. For example, the composition 1021, 1022, or 1023 acquired using the second camera sensor 1020 may include one fourth frame.

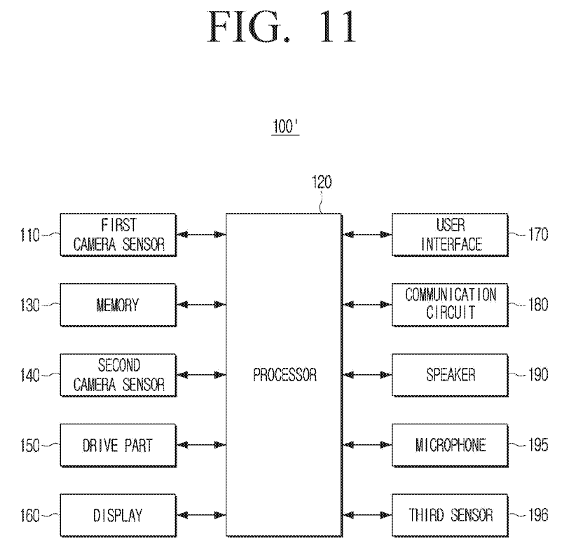

FIG. 11 is a block diagram illustrating a specific configuration of an electronic apparatus according to an embodiment of the disclosure.

Referring to FIG. 11, an electronic apparatus 100' may include the first camera sensor 110, the a processor 120, the memory 130, a second camera sensor 140, a drive part 150, a display 160, a user interface 170, a communication circuit 180, a speaker 190, a microphone 195, and a third sensor 196. Detailed descriptions of the configurations shown in FIG. 11 that overlap with the configurations shown in FIG. 2A are omitted.

The drive part 150 refers to a device that may travel the electronic apparatus 100'. The drive part 150 may adjust a traveling direction and a traveling speed under the control of the processor 120, and the drive part 150 according to an embodiment may include a power generation device that generates power enabling the electronic apparatus 100' to travel (e.g., a gasoline engine, a diesel engine, a liquefied petroleum gas (LPG) engine, or an electric motor depending on a fuel (or energy source) used), a steering device that adjusts the traveling direction (e.g., manual steering, hydraulics steering, or electronic control power steering (EPS)), a travel device that travels the electronic apparatus 100' based on power (e.g., wheels or propellers), or the like. Here, the drive part 150 may be modified and implemented based on a traveling type (e.g., a wheel type, a walking type, or a flight type) of the electronic apparatus 100'.

The display 160 may be implemented as a display including a self-luminous element, or a display including a non-luminous and a backlight. For example, the display 160 may be implemented as various types of displays, such as a liquid crystal display (LCD), an organic light emitting diode (OLED) display, a light-emitting diode (LED) display, a micro LED, a mini LED, a plasma display panel (PDP), a quantum dot (QD) display, and a quantum dot light-emitting diode (QLED) display. The display 160 may also include a driving circuit, a backlight unit, and the like, which may be implemented in a form, such as an a-si thin film transistor (TFT), a low temperature poly silicon (LTPS) TFT, or an organic TFT (OTFT). Meanwhile, the display 160 may be implemented as a touchscreen combined with a touch sensor, a flexible display, a rollable display, a three-dimensional (3D) display, a display in which a plurality of display modules are physically connected with each other, or the like. The processor 120 may control the display 160 to output an output image acquired according to the various embodiments described above. Here, the output image may be a high-resolution image of 4K, 8K, or higher. The output image may also be a game image according to an embodiment.

According to an embodiment of the disclosure, the display 160 may include a plurality of haptic elements. The haptic element may be implemented as a motor for providing haptic feedback (e.g., vibration feedback) to the user, and is not limited thereto. For example, the display 160 may include a predetermined number of haptic elements. For example, the display 160 may include the predetermined number of haptic elements corresponding to a predetermined number of sub-regions of the display. However, the disclosure is not limited thereto, and a different number of haptic elements than the plurality of sub-regions corresponding to the display may be included in the display.

The user interface 170 refers to a component enabling the electronic apparatus 100 to perform interaction with the user. For example, the user interface 170 may include at least one of a touch sensor, a motion sensor, a button, a jog dial, a switch, the microphone, or the speaker, and is not limited thereto.

The communication circuit 180 may input and output various types of data. For example, the communication circuit 180 may transmit and receive the various types of data to and from an external device (e.g., a source device), an external storage medium (e.g., the USB memory), an external server (e.g., a web hard drive) by using a communication method, such as access point (AP)-based wireless fidelity (Wi-Fi, wireless local area network (LAN)), Bluetooth, Zigbee, wired/wireless local area network (LAN), wide area network (WAN), Ethernet, IEEE 1394, high definition multimedia interface (HDMI), universal serial bus (USB), mobile high-definition link (MHL), audio engineering society/European broadcasting union (AES/EBU) communication, optical communication, or coaxial communication.

For example, the communication circuit 180 may include a Bluetooth low energy (BLE) module. The BLE refers to a Bluetooth technology that enables transmission and reception of low-power and low-capacity data in a 2.4 gigahertz (GHz) frequency band having a range of about 10 m. However, the disclosure is not limited thereto, and the communication circuit 180 may include a Wi-Fi communication module. For example, the communication circuit 180 may include at least one of the Bluetooth low energy (BLE) module or the Wi-Fi communication module.

According to an embodiment of the disclosure, the speaker 190 may include a tweeter for reproducing high-frequency sounds, a midrange for reproducing medium-frequency sounds, a woofer for reproducing low-frequency sounds, a subwoofer for reproducing ultra-low-frequency sounds, an enclosure for controlling resonance, a crossover network for dividing a frequency of an electric signal input into the speaker into bands, or the like.

According to an embodiment of the disclosure, the speaker 190 may output an audio signal to the outside of the electronic apparatus 100'. The speaker 190 may output multimedia playback, recording playback, various notification sounds, voice messages, or the like. The electronic apparatus 100' may include an audio output device, such as the speaker 190, and may include an output device, such as an audio output terminal. More particularly, the speaker 190 may provide acquired information, information processed and produced based on the acquired information, a response result to a user voice, or an operation result, or the like in a voice form.

The microphone 195 may refer to a module that acquires sound and converts the same into the electric signal, and may be a condenser microphone, a ribbon microphone, a moving coil microphone, a piezoelectric element microphone, a carbon microphone, or a micro electro mechanical system (MEMS) microphone. In addition, the microphone 195 may be implemented in an omnidirectional, bidirectional, unidirectional, subcardioid, supercardioid, hypercardioid manner. According to an embodiment of the disclosure, the electronic apparatus 100' may include the microphone 195 and an inner microphone, and the microphone 195 may be a microphone positioned relatively outside a body. For example, the electronic apparatus 100' may acquire an audio signal including external noise through the microphone 195. According to an embodiment of the disclosure, the microphone 195 may be disposed in a direction opposite to a direction in which the speaker 190 emits sound.

The third sensor 196 may be implemented as the different type of sensor including the LiDAR sensor, the ultrasonic sensor, the acceleration sensor, the angular velocity sensor, or the gyro sensor. For example, the third sensor 196 may include the RGB sensor. However, the disclosure is not limited thereto, and the third sensor 196 may include a different type of sensor.

In the aforementioned example, the electronic apparatus 100' may adjust the rate of the plurality of types of frames based on the context related to the traveling space. For example, if liquid is suspected to be present on the traveling path, the electronic apparatus 100' may accurately identify liquid present on the traveling path by increasing the third frame rate related to liquid detection. Accordingly, the electronic apparatus 100' may smoothly perform the operation of traveling to avoid liquid or cleaning liquid, thereby improving the user satisfaction.

Meanwhile, according to an embodiment of the disclosure, the various embodiments described above may be implemented in software including an instruction stored on a machine-readable storage medium (for example, a computer-readable storage medium). A machine may be a device that invokes the stored instruction from a storage medium, may be operated based on the invoked instruction, and may include the display device (e.g., display device A) according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term "non-transitory" indicates that the storage medium is tangible without including a signal, and does not distinguish whether data are semi-permanently or temporarily stored on the storage medium.

In addition, according to an embodiment of the disclosure, the methods according to the various embodiments described above may be included and provided in a computer program product. The computer program product may be traded as a commodity between a seller and a purchaser. The computer program product may be distributed in a form of the machine-readable storage medium (for example, compact disc read only memory (CD-ROM)), or may be distributed online through an application store (for example, PlayStore^{TM}. In case of the online distribution, at least a part of the computer program product may be at least temporarily stored or temporarily provided on a storage medium, such as the memory of a manufacturer server, an application store server, or a relay server.

In addition, each of the components (for example, modules or programs) according to the various embodiments described above may include a single entity or a plurality of entities, and some of the corresponding sub-components described above may be omitted or other sub-components may be further included in the various embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a first camera sensor;
memory, comprising one or more storage media, storing instructions; and
at least one processor communicatively coupled to the first camera sensor and the memory,
wherein the instructions that, when executed by the at least one processor individually or collectively, cause the electronic apparatus to:
control the first camera sensor to acquire at least one frame based on at least one first frame rate corresponding to a first operation mode while the electronic apparatus travels in a traveling space in the first operation mode,
switch from the first operation mode to a second operation mode based on context information related to the traveling space, and
control the first camera sensor to acquire at least one frame based on at least one second frame rate corresponding to the second operation mode while the electronic apparatus travels in the traveling space in the switched second operation mode, and
wherein the at least one second frame rate comprises a frame rate which is different from the at least one first frame rate.

2. The electronic apparatus of claim 1, wherein at least one of the at least one first frame rate or the at least one second frame rate corresponds to a ratio of the at least one frame in a predetermined period.

3. The electronic apparatus of claim 1, wherein the instructions, when executed by the at least one processor individually or collectively, further cause the electronic apparatus to:
identify an event while the electronic apparatus travels in a traveling space in the first operation mode;
identify the context information based on the identified event; and
identify at least one operation mode comprising the second operation mode corresponding to the identified context information.

4. The electronic apparatus of claim 3, wherein the event comprises prediction that the electronic apparatus enters a predetermined region.

5. The electronic apparatus of claim 1,
wherein the first camera sensor includes at least one light-emitting element that emits light,
wherein the at least one frame acquired by the first camera sensor comprises a first frame, a second frame, and a third frame,
wherein the first frame is an image acquired based on a first illuminance,
wherein the second frame is an image acquired based on a second illuminance greater than or equal to the first illuminance, and
wherein the third frame is an image acquired based on light emitted at a first angle from the light-emitting element.

6. The electronic apparatus of claim 5,
wherein the context information corresponds to a liquid detection, and
wherein a frame rate corresponding to the third frame in the second operation mode is greater than or equal to a frame rate corresponding to the third frame in the first operation mode.

7. The electronic apparatus of claim 5,
wherein the context information corresponds to an entry event into a dead-end space, and
wherein a frame rate corresponding to the first frame in a third operation mode is greater than or equal to a frame rate corresponding to the first frame in the first operation mode.

8. The electronic apparatus of claim 7, wherein the instructions, when executed by the at least one processor individually or collectively, further cause the electronic apparatus to:
identify whether the dead-end space is present in a traveling path based on map information, and
identify the entry event into the dead-end space based on identifying that the electronic apparatus is within a first distance from the dead-end space.

9. The electronic apparatus of claim 5,
wherein the context information corresponds to a carpet detection, and
wherein a frame rate corresponding to the third frame in the second operation mode is less than a frame rate corresponding to the third frame in the first operation mode.

10. The electronic apparatus of claim 1, further comprising:
a second camera sensor configured to acquire a fourth frame,
wherein at least one of the at least one first frame rate or the at least one second frame rate corresponds to a ratio of the at least one frame acquired using the first camera sensor and the fourth frame in a predetermined period, and
wherein, the instructions, when executed by the at least one processor individually or collectively, further cause the electronic apparatus to:
control at least one of the first camera sensor or the second camera sensor to acquire the at least one frame, and the fourth frame based on the at least one first frame rate while the electronic apparatus travels in the first operation mode, and
control the at least one of the first camera sensor or the second camera sensor to acquire the at least one frame, and the fourth frame based on the at least one second frame rate while the electronic apparatus travels in the switched second operation mode.

11. The electronic apparatus of claim 10,
wherein the first camera sensor comprises an infrared (IR) camera, and
wherein the second camera sensor comprises a red-green-blue (RGB) camera.

12. The electronic apparatus of claim 1, wherein the instructions, when executed by the at least one processor individually or collectively, further cause the electronic apparatus to switch from the second operation mode to the first operation mode based on the context information corresponding to the second operation mode while the electronic apparatus travels in the traveling space in the second operation mode.

13. A method for operating an electronic apparatus, the method comprising:
controlling a first camera sensor to acquire at least one frame based on at least one first frame rate corresponding to a first operation mode while the electronic apparatus travels in a traveling space in the first operation mode;
switching from the first operation mode to a second operation mode based on context information related to the traveling space; and
controlling the first camera sensor to acquire at least one frame based on at least one second frame rate corresponding to the second operation mode while the electronic apparatus travels in the traveling space in the switched second operation mode,
wherein the at least one second frame rate comprises a frame rate which is different from the at least one first frame rate.

14. The method of claim 13, further comprising:
identifying an event while the electronic apparatus travels in a traveling space in the first operation mode;
identifying the context information based on the identified event; and
identifying at least one operation mode comprising the second operation mode corresponding to the identified context information.

15. The method of claim 13,
wherein the first camera sensor includes at least one light-emitting element that emits light,
wherein the at least one frame acquired by the first camera sensor comprises a first frame, a second frame, and a third frame,
wherein the first frame is an image acquired based on a first illuminance,
wherein the second frame is an image acquired based on a second illuminance greater than or equal to the first illuminance, and
wherein the third frame is an image acquired based on light emitted at a first angle from the light-emitting element.

16. The method of claim 15,
wherein the context information corresponds to a liquid detection, and
wherein a frame rate corresponding to the third frame in the second operation mode is greater than or equal to a frame rate corresponding to the third frame in the first operation mode.

17. The method of claim 16, wherein the context information corresponds to an entry event into a dead-end space, and
wherein a frame rate corresponding to the first frame in a third operation mode is greater than or equal to a frame rate corresponding to the first frame in the first operation mode.

18. The method of claim 17, wherein the context information corresponds to a carpet detection, and
wherein a frame rate corresponding to the third frame in the second operation mode is less than a frame rate corresponding to the third frame in the first operation mode.

19. The method of claim 13,
wherein at least one of the at least one first frame rate or the at least one second frame rate corresponds to a ratio of the at least one frame acquired using the first camera sensor and a fourth frame acquired using a second camera sensor in a predetermined period, and
wherein the method further comprises:
controlling at least one of the first camera sensor or the second camera sensor to acquire the at least one frame and the fourth frame based on the at least one first frame rate while the electronic apparatus travels in the first operation mode, and
controlling the at least one of the first camera sensor or the second camera sensor to acquire the at least one frame and the fourth frame based on the at least one second frame rate while the electronic apparatus travels in the switched second operation mode.

20. One or more non-transitory computer-readable storage media storing one or more computer programs including computer-executable instructions that, when executed by at least one processor of an electronic apparatus individually or collectively, cause the electronic apparatus to perform operations, the operations comprising:
controlling a first camera sensor to acquire at least one frame based on at least one first frame rate corresponding to a first operation mode while the electronic apparatus travels in a traveling space in the first operation mode;
switching from the first operation mode to a second operation mode based on context information related to the traveling space; and
controlling the first camera sensor to acquire at least one frame based on at least one second frame rate corresponding to the second operation mode while the electronic apparatus travels in the traveling space in the switched second operation mode,
wherein the at least one second frame rate comprises a frame rate which is different from the at least one first frame rate.
